(19) United States
(12) Patent Application Publication
(10) Pub. No.: US 2004/0250025 A1
(43) Pub. Date: Dec. 9, 2004

(54) Method for creating a static address table and data network

(76) Inventors: Dieter Bruckner, Unterleiterbach (DE); Franz-Josef Gotz, Heideck (DE); Dieter Klotz, Furth (DE); Jurgen Schimmer, Nurnberg (DE)

Correspondence Address: Siemens Corporation, Intellectual Property Department, 170 Wood Avenue South, Iselin, NJ, 08830, US

(21) Appl. No.: 10/489,470

(22) PCT Filed: Sep. 13, 2002
(86) PCT No.: PCT/DE02/03433

(30) Foreign Application Priority Data
Sep. 26, 2001 (DE) 101474121

(51) Int. Cl. G06F 12/00; G06F 13/00

(52) U.S. Cl. 711/149; 713/163

(57) ABSTRACT

The invention relates to a data network and a method for creating a static address table for a number of target addresses. Said method comprises the following steps: replication of each of the target addresses in an entry address of the address table; if a subset of the number of target addresses is replicated in the same entry address: a) the entry address is allocated to one of the target addresses of the subset, b) the entry address is allocated with an offset to each of the remaining target addresses of the subset, c) one or more transmission ports is/are saved in the address table, together with the relevant target address, for each target address of the number in one or more locations that is/are characterized by the respective entry address or by the respective entry address with one or more offsets.

### CROSS REFERENCE TO RELATED APPLICATIONS

This application is the US National Stage of International Application No. PCT/DE02/03433, filed Sep. 13, 2002 and claims the benefit thereof. The International Application claims the benefits of German application No. 10147412.1 filed Sep. 26, 2001, both of the applications are incorporated by reference herein in their entirety.

### FIELD OF INVENTION

The invention relates to a method for generating a static address table for a set of target addresses as well as a method for transmitting a data telegram with a target address in a data network and a corresponding switching node in the data network.

### BACKGROUND OF INVENTION

Various types of data networks are known from the prior art in which the data network components take a decision on which port of the data network component in question is to be used to send a data telegram. Also known in particular are what are termed “switchable data networks”, in which a connection in the data network is established between two subscribers by means of one or more point-to-point connections.

It is also known per se from the prior art that the decision as to which port of a data network component is to be used to send a previously received data telegram is taken with the aid of an address table. Each entry in the address table stores for example the station address of a target data network component (referred to as a unicast address) or a multicast address or a network address as well as the numbers of the ports of the data network component in question, via which ports a received data telegram is to be sent for forwarding to its target address.

Also known from the prior art is the use of dynamically modifiable and static address tables. Dynamic address tables have dynamically modifiable table entries which are administered independently by the hardware of the data network component in question without software support. On the other hand, the static entries in a static address table are administered by the application software of each data network component and must not be modified by the hardware of a data network component.

A method, known from the prior art, of detecting whether an address, for example a multicast address, and the information assigned to the multicast address are stored in an address table is the direct comparison of the target address of the data telegram in question with all the addresses stored in the address table. This method is time-intensive or requires a content-addressable memory.

A method which permits address entries which are initially mapped to the same entry address of the address table to be simultaneously stored in an address table is described in U.S. Pat. No. 5,923,660. For this purpose there is provided in an Ethernet controller a hash address table with a corresponding controller which forms the hash value of the address of a data packet in order to find an initial value for an entry into the hash address table. This initial value is modified if necessary by a fixed shift value if the address which is contained in the row of the hash address table located by the initial value does not tally with the received target address.

Data networks support communication between a number of subscribers by networking, i.e. interconnection of the individual subscribers. Communication in this context means the transmission of data between the subscribers. The data to be transmitted is sent here as data telegrams; in other words, the data is gathered into a number of packets and sent in this form via the data network to the corresponding receiver. For this reason such data is also referred to as data packets.

The term “transmission of data” is used here synonymously with the above-mentioned transmission of data telegrams or data packets. The networking itself is achieved for example in switchable high-performance data networks, in particular Ethernet, in that at least one switching unit which is connected to two subscribers is inserted into the circuit in each case between the two subscribers. Each switching unit can be connected to more than two subscribers.

Each subscriber is connected to at least one switching unit, but not directly to another subscriber. Subscribers are for example computers, stored program controls (SPC) or other machines which exchange, and in particular process, electronic data-with other machines. In contrast to bus systems, in which each subscriber can reach every other subscriber of the data network directly via the data bus, the switchable data networks use only point-to-point connections, which means that a subscriber can reach all other subscribers of the switchable data network only indirectly, by appropriate forwarding of the data to be transmitted by means of one or more switching units.

In distributed automation systems, for example in the drive engineering sector, certain data must arrive at specific times at the intended subscribers and be processed by the recipients. This is referred to as realtime-critical data or data communication, since if the data does not arrive at the right time at its destination this can lead to undesirable results for the subscriber. According to IEC 61491, EN61491 SERCOS Interface—Technische Kurzbeschreibung (“Brief Technical Description”, http://www.sercos.de/deutsch/indexdeutsch.htm) a successful realtime-critical data communication of the type mentioned can be guaranteed in distributed automation systems.

Various standardized communication systems, also Galled bus systems, are known from the prior art for exchanging data between two or more electronic modules or devices, in particular also for use in automation systems. Examples of such communication systems are: Fieldbus, Profibus, Ethernet, Industrial Ethernet, Firewire or also PC-internal bus systems (PCI). These bus systems are each designed or optimized for different fields of application and permit a decentralized control system to be set up. Very fast and reliable communication systems with predictable response times are necessary for process control and monitoring in automated production and in particular for digital drive systems.

Very fast and simple communication can be set up between different modules using parallel bus systems such as, for example, SMP, ISA, PCI or VME. These known bus systems are used in particular in computers and PCs.

Synchronous, clock-controlled communication systems with equidistance properties are known in particular from automation technology. By this is meant a system comprising at least two subscribers that are interconnected via a data network for the purpose of reciprocal exchange of data or reciprocal transmission of data. In this case the data exchange takes place cyclically in equidistant communication cycles which are predetermined by the communication clock timing used by the system. Subscribers are for example central automation devices, programming, planning or control devices, peripheral devices such as, for example, input/output modules, drives, actuators, sensors, stored program controls (SPC) or other control units, computers, or machines which exchange electronic data with other machines, and in particular process data from other machines. In the following control units are understood to mean regulating or controlling units of any kind.

An equidistant deterministic cyclical data exchange in communication systems is based on a common clock or time base for all the components involved in the communication. The clock or time base is transmitted to the other components by a specially designated component (clock timer). With isochronous realtime Ethernet, the clock or time base is specified by a synchronization master by the sending of synchronization telegrams.

The German patent application DE 100 58 524.8 discloses a system and a method for the transmission of data via switchable data networks, in particular the Ethernet, which permits a mixed form of operation comprising realtime-critical and non-realtime-critical, in particular Internet- or intranet-based data communication.

### SUMMARY OF INVENTION

The object of the invention is to create an improved method for generating a static address table, in particular for a switching unit in a data network, as well as an improved method for transmitting a data telegram and a corresponding improved switching node and a computer program product.

The object underlying the invention is achieved in each case by the features of the independent claims. Preferred embodiments of the invention are specified in the dependent claims.

The invention permits a set of target addresses of a target address space to be mapped to a set of entry addresses of a static address table. For example, 48-bit Ethernet station addresses are mapped to entry addresses with a length of, for example, 6 or 8 bits.

Preferably the mapping is performed here in such a way that an entry address is assigned uniquely (one-to-one) to each Ethernet station address; in other words, one and the same entry address is assigned to precisely one Ethernet station address only.

It can however happen that owing to the much smaller address space of the entry addresses compared to the address space of the station addresses, i.e. the target addresses, two target addresses are mapped to the same entry address. To allow for this case, according to the invention the entry address is assigned to only one of the target addresses. The entry addresses of the further target addresses for which the mapping has produced the same entry address are identified by different offsets.

According to a preferred preferred embodiment of the invention, a static address table with N entries, each M bytes long, is generated in a contiguous memory area of (N * M) bytes. This method also permits the simultaneous storing of entries in the address table which were initially mapped to the same entry address.

According to a preferred embodiment of the invention, an address table according to the invention is present in each switching node of the data network. Each row in such an address table contains at least one target address and the specification of one or more ports of the switching node, depending on whether the target address in question is a unicast or a multicast address. An offset can also be provided in the relevant row of the address table.

In addition, each row of the address table contains an entry indicating whether the offset entered in this row is valid. This is possible by means of a special Offset Valid bit in this row or by means of an end identifier in the offset field of this row. An offset entered in a row of the address table is valid precisely when the offset points to a further entry in the address table in which a different target address is entered which has been mapped to the same entry address as the target address of the table entry which has just been read out.

When a data telegram is received at one of the ports of the switching node during operation of the data network, the target address contained in the data telegram is read first. This target address is then mapped to an entry address in the address table. By means of the entry address obtained in this way, the corresponding row in the address table is accessed. The target address stored in the relevant row of the address table is then compared with the target address of the received data telegram. If these match, the data telegram is forwarded via the port or ports specified in the relevant row of the address table.

If there is no agreement between the target address, the address table and the target address of the data telegram, this is a case in which either the target address of the data telegram is not stored in the address table or this target address is one of two or more target addresses which have been mapped to the same entry address.

If the offset of the read-out row of the address table is not valid or if the target address of the data telegram is not stored in the address table, then the data telegram is sent analogously to a broadcast telegram via all ports of the switching node with the exception of the receive port.

If, on the other hand, the offset of the read-out row of the address table is valid, this target address may be stored at another location in the address table. To allow for this case, the row of the address table identified by the entry address contains an offset. Based on this offset, the address table is accessed a second time, with the original entry address being incremented by the offset.

The target address in the row of the address table located by the entry address incremented by the offset, is again compared with the target address of the data telegram. If no match can again be established, a check must again be made to determine whether the offset entered in this row is valid. If this is not the case, the data telegram is handled similarly to a broadcast telegram. If the offset is valid, however, the offset of this address row is accessed in order to increment the entry address again by this offset.

Using the entry address re-incremented in this way, the relevant row in the address table is accessed in order to make a fresh comparison of the target addresses in the address table and in the data telegram. This process is repeated until a row in the address table with an invalid offset is found or until a row in the address table with a target address which matches the target address of the data telegram is found. In the first case (i.e. invalid offset) the data telegram is sent analogously to a broadcast telegram. In the second case (i.e. the target address has been found) the data telegram is forwarded via the port or ports specified in this row of the address table, depending on whether the address is a unicast or a multicast address.

If the data telegram is forwarded in this way by the switching node to a further switching node via a point-to-point connection, then this operation is repeated in the switching node in question. In this way the data telegram takes a particular path, or a plurality of paths in the case of a multicast address, through the data network, whereby the method according to the invention is used in each of the switching nodes of the path(s).

According to a further preferred embodiment of the invention, a linear feedback shift register (LFSR) is used for mapping the set of target addresses to the entry addresses.

Preferably, the feedback of the LFSR is parameterized here in such a way that a predetermined set of target addresses is mapped as far as possible on a one-to-one basis to a set of entry addresses or in such a way that as far as possible two or more of the target addresses are assigned to only a few entry addresses.

### BRIEF DESCRIPTIONS OF THE DRAWINGS

A preferred embodiment of the invention will be explained in the following with reference to the drawings, in which:

FIG. 1 shows a block diagram of a section from a data network according to the invention with switching nodes,

FIG. 2 shows the address tables of two different switching nodes,

FIG. 3 shows an embodiment of a linear feedback shift register (LFSR) for mapping the target addresses to entry addresses into the address tables,

FIG. 4 shows a flowchart of an embodiment of the method according to the invention for generating an address table.

### DETAILED DESCRIPTION OF INVENTION

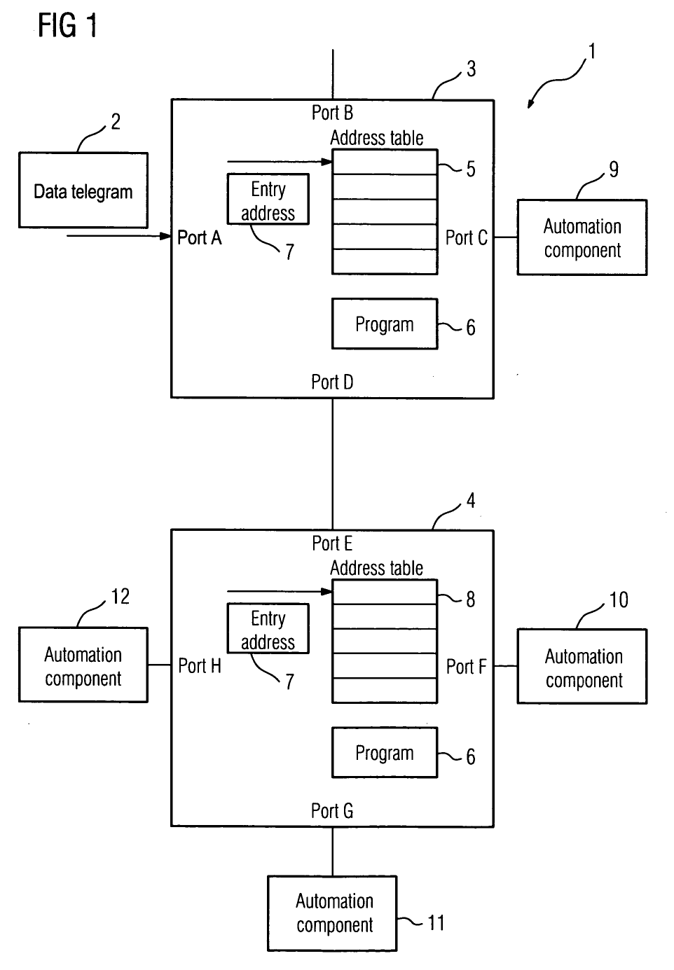

FIG. 1 shows a section from a data network 1. The data network 1 is a switched data network in which a data telegram 2 is transmitted by means of point-to-point connections via the switching nodes 3 and 4 of the data network 1 as well as, where applicable, further switching nodes which, for the sake of clarity, are not shown in FIG. 1.

The switching node 3 has the ports A, B, C and D. If necessary, a point-to-point connection can be set up via each of the ports A to D of the switching node 3 to the respective adjacent node in the data network 1. For example, in the application instance shown in FIG. 1 the switching node 3 receives a data telegram 2 from an adjacent node in the data network 1.

This data telegram 2 contains a target address. The target address can be a unicast, multicast or broadcast address. If it is a broadcast address, the data telegram received at the port A is forwarded via all the other ports B, C and D.

If the data telegram 2 contains a unicast or a multicast target address, an access to the address table 5 of the switching node 3 is necessary in order to determine the port or ports of the switching node 3 via which the data telegram 2 is to be forwarded.

The address table 5 contains a plurality of rows, i.e., for example, 64 or 128 rows. Each of these rows contains a target address with a specification assigned to the target address indicating those ports of the relevant switching node 3 via which a received data telegram 2 is to be forwarded.

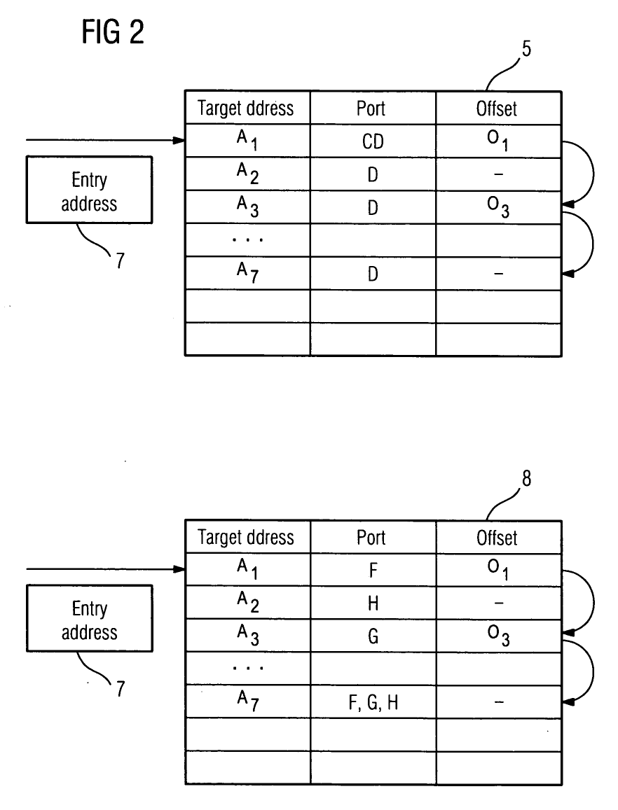

To access the address table 5, an entry address 7 is formed from the target address of the data telegram 2 by means of the program 6 of the switching node 3. A row in the address table 5 is uniquely identified by means of the entry address 7. This row of the address table 5 is then accessed in order to locate the port or ports via which the data telegram 2 is to be forwarded. Toward that end it may be necessary to increment the entry address 7 one or more times by means of offsets stored in the address table 5 in order to get to the required row in the address table 5. The corresponding method is explained in more detail below with reference to FIGS. 2, 3 and 4.

The switching node 4 is in principle identical in structure to the switching node 3. The switching node 4 has the ports E, F, G and H and also an address table 8. The address table 8 is formed according to the same principles as the address table 5, but is not identical to the address table 5. The address table 8 contains in particular the specifications of those ports via which a data telegram to be received by the switching node 4 is to be forwarded. The program 6 is again used to determine the entry address 7 into the address table 8 based on the target address of a data telegram 2 received in the switching node 4.

The switching nodes 3 and 4 are interconnected via their ports D and E respectively by means of a cable. The switching node 3 is connected via its port B to a further switching node which is not shown in FIG. 1. An automation component 9 is located at port C of the switching node 3.

The switching node 4 is additionally connected at its port F to an automation component 10, at its port G to an automation component 11, and at its port H to an automation component 12.

The automation components 9 to 12 can be any components used for controlling, adjusting or monitoring an installation, such as, for example, sensors, controllers, setpoint controllers, drives, stored program controls (SPC), input/output modules, etc.

FIG. 2 shows the structure of the address table 5 and the address table 8 in detail. The target address to which a row belongs is stored in the relevant row of the address tables 5 and 8. The target address is a specification of the port or ports of the relevant switching nodes 3 and 4 via which a received data telegram with the target address is to be forwarded. Such a row also contains an offset in case the relevant target address has not been mapped one-to-one to an entry address.

The target address A₁, for example, is a multicast address by means of which a data telegram 2 is addressed to the automation components 9 and 10. The target address A₂, on the other hand, is a unicast address by means of which only the automation component 12 is addressed. The target address A₃ is similarly a unicast target address by means of which the automation component 11 is addressed. Moreover, the target address A₇ is a multicast address by means of which the automation components 10, 11 and 12 are addressed.

In the following it is assumed, without limiting the general applicability of the invention, that the target addresses A₂, A₃ and A₇ are mapped to the same entry address 7. To allow for this case, the row of the target address A₁ in the address table 5 contains a valid offset O₁, the row of the target address A₃ a valid offset O₃, and the row of the target address A₇ an invalid offset.

If a data telegram 2 with the target address A₂ is received, the following steps are performed: The target address A₂ of the data telegram 2 is mapped to an entry address 7. By means of this entry address 7, the row of the target address A₂ in the address table 5 can be accessed directly. Since the target address A₂ stored in the relevant row of the address table 5 matches the target address A₂ of the data telegram 2, the specification of the port D is read and the data telegram 2 forwarded via the port D to the switching node 4 (cf. FIG. 1).

If, on the other hand, a data telegram 2 with the target address A₁ is received, an entry address 7 is likewise generated from the target address of the data telegram 2 by means of the program 6. By means of the entry address 7, an access is then executed to the address table 5, and more specifically directly to the row in the address table 5 with the target address A₁. Since the specifications of the target addresses in the relevant row of the address table 5 and in the data telegram 2 again match, the specification of the ports C and D in the row is accessed and the data telegram forwarded via the relevant ports C and D to the automation component 9 or to the port E of the switching node 4. Accessing the valid offset O₁ in the relevant row of the address table 5 is not necessary in this case.

If, on the other hand, a data telegram 2 with the target address A₇ is received, then the target address A₇ is mapped to the same entry address 7 as the target address A₂. Similarly, the row in the address table 5 of the target address A₂ is accessed first. A comparison of the target address A₂ of the data telegram 2 with the target address A₁ of the row of the address table 5 identified by the entry address 7 then results in a discrepancy, so the valid offset O₁ of the relevant row is accessed.

The entry address 7 is then incremented by the offset O₁. The address table 5 is then accessed again by means of the entry address 7 incremented by the offset O₁. The relevant row of the address table 5 is the row with the target address A₃. A comparison of the target address A₇ of the data telegram 2 with the target address A₃ of the relevant row of the address table 5 again reveals a discrepancy, with the result that the valid offset O₃ of this row is accessed. The entry address 7 is then incremented in addition by the offset O₃, so that the entry address 7 incremented in this way then points to the row of the target address A₇ in the address table 5. A comparison of the target address A₇ of the data telegram 2 with the target address A₇ of the relevant row then reveals the agreement of the relevant target addresses, so the specification of the corresponding port D in this row of the address table 5 is then accessed in order to forward the data telegram 2 via this port D.

The address table 8 is structured analogously, with the target addresses being assigned to those ports of the switching node 4 via which a received data telegram 2 is to be forwarded.

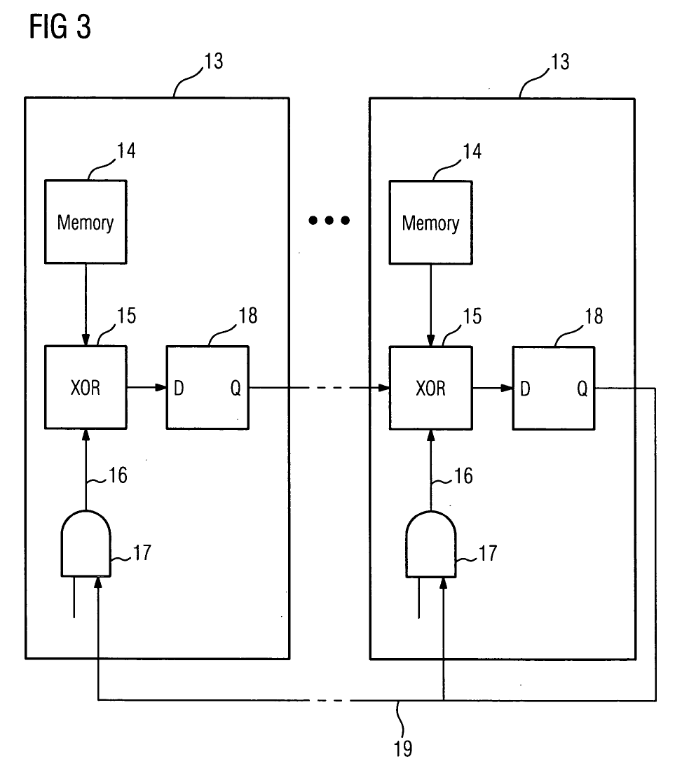

FIG. 3 shows an embodiment of a linear feedback shift register (LFSR) which can be used for mapping target addresses to entry addresses.

The linear feedback shift register shown in FIG. 3 contains a certain number of shift register elements 13. Each shift register element has a memory 14 which is connected to the input of an XOR gate 15. The XOR gate 15 also has a feedback input 16, upstream of which an AND gate 17 is included in the circuit.

The output of the XOR gate 15 is connected to the D input of a flip-flop 18. The Q output of the flip-flop 18 is at the same time the output of the shift register element 13. This output is connected to the input of the next following shift register 13 in the chain of shift registers. The output of the last shift register in the chain is connected via a feedback path 19 to one input in each case of the AND gates 17 of the individual shift register elements. Depending on how the respective other input of the AND gate 17 is occupied, the feedback is then applied or not applied to the relevant XOR gate 15.

In order to map a target address to an entry address, the target address is clocked in via the memories 14 of the shift register elements 13. The contents of the flip-flops 18 are then read out. This produces the entry address of the relevant target address. This process is repeated for each of the target addresses. The inputs of the AND gates 17 are parameterized here in such a way that as far as possible only one entry address is assigned uniquely (one-to-one) to each target address. However, since the address space of the target addresses is considerably larger than the address space of the entry addresses, it cannot always be avoided that two or more target addresses are assigned to the same entry address in this way.

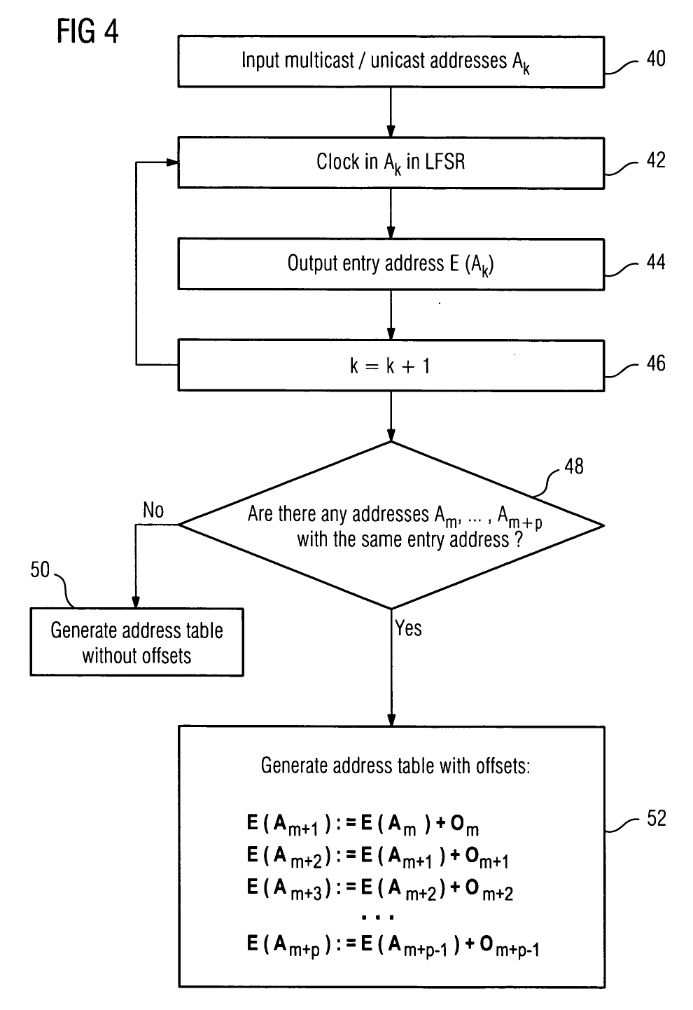

FIG. 4 shows a flowchart which discloses how an address table corresponding to the address tables 5 and 8 shown in FIGS. 1 and 2 can be generated on the basis of the mapping thus obtained of the target addresses to entry addresses.

In step 40, a set of a number N target addresses Aₖ is entered. These target addresses Aₖ can be multicast and/or unicast target addresses.

In step 42, the target address Aₖ is clocked into a linear feedback shift register—corresponding to the shift register shown in FIG. 3. As an alternative to the clocking into a feedback shift register of this kind, a pure software-engineered solution is also advantageous.

From this results a corresponding mapping of the target address Aₖ to an entry address E(Aₖ) which is output in step 44. In step 46, the index k is then incremented and the next target address Aₖ is mapped to its entry address in steps 42 and 44. This process is repeated until all N target addresses Aₖ have been mapped to entry addresses E (Aₖ).

In step 48, a check is then made to determine whether there are any target addresses Aₘ, . . . , Aₘ₊ₚ with the same entry address. In other words, a check is made to discover whether two or more of the target addresses have been mapped to the same entry address.

If this is not the case, then in step 50 the address table is generated, this being done directly on the basis of the one-to-one entry addresses E(Aₖ).

If, however, the opposite is the case, then the address table is generated in step 52. The entry address E(Aₘ) is used as an entry address into the table for the target address Aₘ. This entry address is therefore already occupied. This entry address must be incremented for the further target addresses Aₘ₊₁ to Aₘ₊ₚ in order to point in each case to a free row in the address table for the relevant target address. The entry address for the target address Aₘ₊₁ is formed here such that an offset Oₘ is added to the entry address E(Aₘ). Similarly, the entry address E(Aₘ₊₂) is obtained by a further incrementation of the entry address by the offset Oₘ₊₁. This process continues until a free address row in the address table is assigned for all target addresses Aₘ₊₁ to Aₘ₊ₚ by repeated incrementation of the original entry address E(Aₘ).

In order to distribute the addresses Aₘ, . . . , Aₘ₊ₚ to the remaining free memory areas, which addresses are mapped to the same entry address of the address table by means of the LFSR, valid offset addresses are entered in each of the table entries assigned to these addresses Aₘ, . . . , Aₘ₊ₚ₋₁, said offset addresses specifying the offset with respect to the free memory locations. In the assigned table entry of the address Aₘ₊ₚ, the offset address should be identified as not valid, since this table entry is only read out if the received target address of a data telegram has not been found in the assigned table entries of the addresses Aₘ, . . . , Aₘ₊ₚ₋₁ and only the addresses Aₘ, . . . , Aₘ₊ₚ have been mapped to the same entry address by the LFSR.

Thus, the following applies to the entry addresses of Aₘ, . . . , Aₘ₊ₚ:

Entry address of Aₘ: =LFSR contents after the clocking in of the address Aₘ

Entry address of Aₘ₊₁: =entry address of Aₘ+offset address of the table entry of Aₘ

Entry address of Aₘ₊₂: =entry address of Aₘ₊₁+offset address of the table entry of Aₘ₊₁

Analogously until:

Entry address of Aₘ₊ₚ: =entry address of Aₘ₊ₚ₋₁+offset address of the table entry of Aₘ₊ₚ₋₁

A particular advantage of the address tables generated in this way is that they occupy a contiguous area of memory, thereby enabling very fast access to the required rows in the address table with little hardware overhead in order to retrieve the information required for forwarding a data telegram. Because of the speed of this method, an advantageous application is realized, in particular also realtime Ethernet communication, in the fieldbus area for example.

1. A method for generating a static address table which occupies a contiguous area of memory for a set of target addresses, comprising:
mapping of the target addresses to an entry address of the address table if a subset of the set of target addresses is mapped to the same entry address:
assigning the entry address to one of the target addresses of the subset;
assigning the entry address with an offset to each of the further target addresses of the subset;
storing one or more send ports in the address table for each target address of the set at a location identified by the respective entry address or by the respective entry address with one or more offsets together with the relevant target address.

2. The method according to claim 1, wherein the target addresses are unicast and/or multicast target addresses.

3. The method according to claim 1, wherein the mapping of a target address to an entry address is performed by a linear feedback shift register.

4. A method for transmission of a data telegram having a target address in a data network, comprising:
mapping the target address to an entry address of a static address table, the static address table occupying a contiguous area of memory;
accessing a row of the address table determined by the entry address, each row of the address table having a target address, a specification of one or more send ports and, an either valid or invalid offset if the mapping is not one-to-one;
checking whether the target address of the data telegram tallies with the target address in the row of the address table identified by the entry address.

5. The method according to claim 4, wherein the target address of the data telegram is a unicast or multicast target address.

6. A switching node for a data network having a plurality of communication ports, comprising:
a static address table which occupies a contiguous area of memory, wherein each row of the address table has a target address, a specification of one or more send ports and, in addition, an offset if the mapping is not one-to-one; and
a mechanism for generating a mapping of a target address of a received data telegram for generating an entry address into the address table.

7. The switching node according to claim 6, wherein the target address is a unicast or a multicast target address.

8. The switching node according to claim 6, wherein the mechanism for generating a mapping is a linear feedback shift register.

9. The switching node according claim 6, wherein the switching node is used in an automation component.

10. The switching node according claim 6, wherein a plurality of switching nodes are used to form a data network.

11. A computer program product for performing a method for generating a static address table, the method comprising:
mapping of the target addresses to an entry address of the address table;
if a subset of the set of target addresses is mapped to the same entry address:
assigning the entry address to one of the target addresses of the subset;
assigning the entry address with an offset to each of the further target addresses of the subset;
storing one or more send ports in the address table for each target address of the set at a location identified by the respective entry address or by the respective entry address with one or more offsets together with the relevant target address.

12. The method according to claim 2, wherein the mapping of a target address to an entry address is performed by a linear feedback shift register.

13. The switching node according to claim 7, wherein the mechanism for generating a mapping is a linear feedback shift register.

14. The method according to claim 4, wherein if the target address is not tally and a valid offset is entered, accessing to the offset and repeating access to the address table by the entry address and the offset.

15. The method according to claim 4, wherein if the target address is not tally and an invalid offset is entered, the target address of the received data telegram is not entering in the address table and the unicast or multicast telegram be forwarded analogously to a broadcast telegram.

16. The method according to claim 4, further comprising repeating of the checking.
